(19) United States
(12) Patent Application Publication
(10) Pub. No.: US 2003/0210249 A1
(43) Pub. Date: Nov. 13, 2003

(54) System and method of automatic data checking and correction

(76) Inventor: Steven J. Simske, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/141,303

(22) Filed: May 8, 2002

(51) Int. Cl. G09G 5/00

(52) U.S. Cl. 345/581

(57) ABSTRACT

A method of automatic data checking and correction comprises the steps of receiving a textual input, and associating at least one attribute value in the textual input with at least one respective element and attribute in the textual input. The method further comprises the steps of comparing the at least one attribute value from the textual input with at least one attribute value stored in a database for the respective element and attribute, and then replacing the at least one attribute value in the textual input with the stored attribute value in response to the at least one attribute value being different from the respective stored attribute value. A system for performing the same is also described.

### TECHNICAL FIELD OF THE INVENTION

The present invention relates generally to the field of computers and computer software, and more particularly to the system and method of automatic data checking and correction.

### BACKGROUND OF THE INVENTION

Speed and efficiency are characteristics prized by today's corporations and corporate employees to achieve even higher productivity. Much of what today's employees perform involves facts and data. Information is collected, entered, processed, analyzed, massaged, reformatted, and re-disseminated at a high rate.

Currently, some word-processing software offers automatic spelling and grammar checking and correction. As the user enters text into a document, the misspelled words and grammatically-incorrect phrases or sentences are highlighted. Furthermore, the user may also configure the program to substitute corrected words for commonly mis-entered words on-the-fly. These features help to improve the user's efficiency by automatically providing spelling and grammar corrections and thus obviating the need for the user to manually lookup the words and grammar rules.

### SUMMARY OF THE INVENTION

In accordance with an embodiment of the present invention, a method of automatic data checking and correction comprises receiving a textual input, and associating at least one attribute value in the textual input with respective at least one element and attribute in the textual input. The method further comprises comparing the at least one attribute value from the textual input with at least one attribute value stored in a database for the respective element and attribute, and replacing the at least one attribute value in the textual input with the stored attribute value in response to the at least one attribute value being different from the at least one respective stored attribute value.

In accordance with another embodiment of the invention, a method of automatic factual data delivery to the desktop comprises receiving a textual input, and associating the at least one attribute value in the textual input with respective at least one element and attribute in the textual input. The method also comprises querying a database regarding the at least one attribute value associated with the at least one element and attribute, and retrieving the queried at least one attribute value. The at least one attribute value from the textual input are compared with the at least one attribute value retrieved from the database for the respective element and attribute. The at least one attribute value in the textual input is then replaced with the at least one stored attribute value if the at least one attribute value is different from the respective retrieved attribute value.

In accordance with yet another embodiment of the present invention, a system of automatic data checking and correction comprises a computer-readable medium having encoded thereon a process. The process is operable to receive an input, and compare attribute values in the input with attribute values stored in a database for respective elements and attributes, and replace the attribute values in the input with the stored attribute values if the attribute values are different from the respective stored attribute values.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of an embodiment of a system for automatic data checking and correction according to the present invention;

FIG. 2 is a flowchart of an embodiment of a data collection process according to the teachings of the present invention;

FIG. 3 is a flowchart of an embodiment of a data auto-correction process according to the teachings of the present invention; and

FIG. 4 is a graphical representation of an exemplary pop-up notification window according to the teachings of the present invention.

### DETAILED DESCRIPTION OF THE DRAWINGS

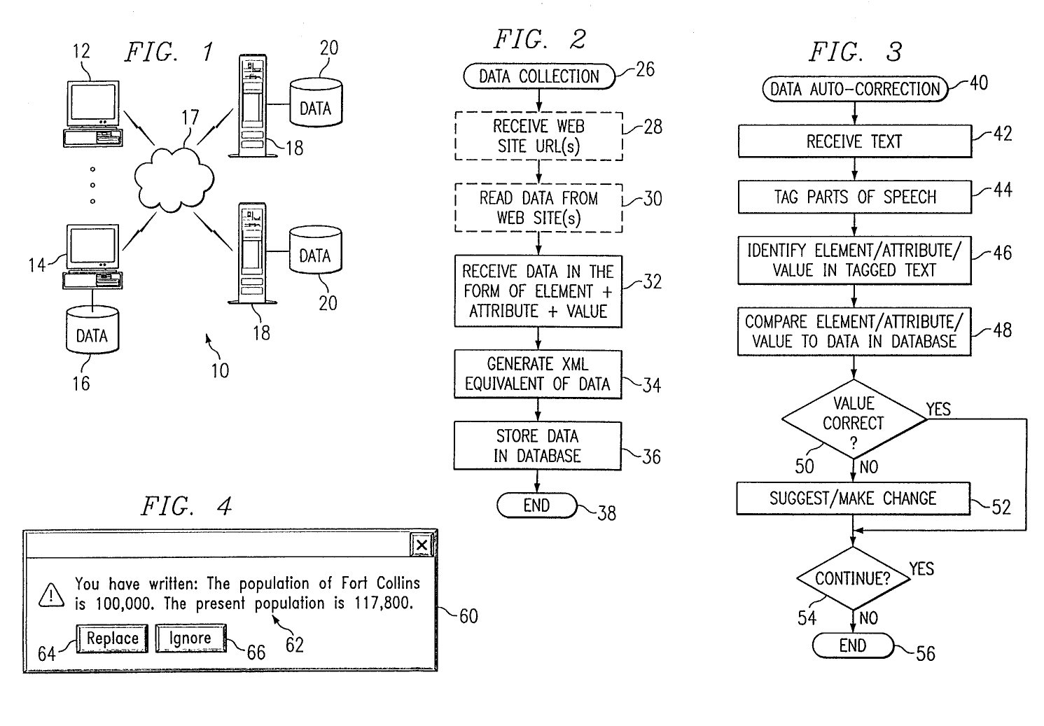

The preferred embodiment of the present invention and its advantages are best understood by referring to FIGS. 1 through 4 of the drawings, like numerals being used for like and corresponding parts of the various drawings.

FIG. 1 is a simplified block diagram of a system for automatic data checking and correction 10 according to an embodiment of the present invention. Automatic data checking and correction system 10 may comprise one or more computers 12 and 14 that executes one or more software applications, such as web browser applications, applets, word processing applications, and other conventional software where textual data are received, displayed or otherwise processed in some manner. To such software applications is added a new feature that performs automatic data checking and correction according to the teachings of the present invention. The data checking and correction feature of the present invention may be implemented in the form of a plug-in application or be simply an integral part of the software applications that process text. Data held to be factual and will be used to perform data checking and correction may be stored in a memory database 16 co-located with computer 14 (as shown), or a memory or database 20 located remotely therefrom. A computer network 17 provides the connectivity between computers 12 and 14 and remote computer servers 18 and fact databases 20 associated therewith. Computer network 17 may include one or more networks such as local area networks, intranets, extranets, and also the Internet, which provides further connectivity to the World Wide Web. Furthermore, computers 12 and 14 may be computing devices ranging in execution power such as personal digital assistants, laptops, personal computers, workstations, etc.

FIG. 2 is a flowchart of an embodiment of a data collection process 26 according to the teachings of the present invention. Data collection process 26 may begin by receiving from a specific file or from a user a web-site uniform resources locator (URL), as shown in block 28. The specified web-site has been previously identified as a source of factual data. Process 26 then reads the data from the identified web-site, as shown in block 30. Steps 28 and 30 are provided as one example of a data source. Alternatively, data may be obtained from a specified file located at a co-located database 16 or a remote database 20. The data obtained in this manner may be in a specific format, such as XML (eXtensible Markup Language), a database format, or another suitable format. The data may also be in a formatted or unformatted text or ASCII (American Standard Code for Information Interchange) format. Other possible sources of data include telephone and address directories, encyclopedias, medical reference books, pharmaceutical references books, biographies, autobiographies, textbooks, etc. In block 32, the data is received and identified as an element, an attribute, or a value. When the data is received in a specific and structured format such as XML or a database format such as a relational database format or spreadsheet format, the data is easily identified as such. However, if the data is received as formatted or unformatted text, for example, some text processing may be performed to tag or identify parts of the speech or text. This step is discussed in more detail below in conjunction with the data auto-correction process shown in FIG. 3. In block 34, the data is then converted to a specific representation, such as XML or another SGML (Standard Generalized Markup Language) based representation. The data is then stored in a remote or co-located database, as shown in block 36. The process ends in block 38.

For example, the data may be stored in a format that can easily lend itself to the element/attribute/value structure. The data may be initially tagged and stored in this manner:

| Country | Capital City |
|---|---|
| Czech Republic | Prague |
| Norway | Oslo |
| Sweden | Stockholm |
| Egypt | Cairo |

Thereafter, the data may be stored in an exemplary element, attribute, attribute value data structure:

| Element (Country) | Attribute | Attribute Value |
|---|---|---|
| Czech Republic | Capital City | Prague |
| Norway | Capital City | Oslo |
| Sweden | Capital City | Stockholm |
| Egypt | Capital City | Cairo |

The tabular form shown above is for illustrative purposes only. The XML representation for the above data may be:

<Fact>

<Country>

<Name>CzechRepublic</Name>
<Capital City>Prague</Capital City>

</Country>

</Fact>

The element/attribute/value format is flexible and can be easily extended to cover the majority of fact patterns. For example, the structure can be extended to historical and conditional facts, as well as element/attribute/value that is not a one-to-one mapping. An example of this is:

<Fact>

<Date>30 08 2001</Date>
<Condition>All</Condition>
<Country>

<Name>Bolivia</Name>
<Capital City>La Paz</Capital City>
<Capital City>Sucre</Capital City>

</Country>

</Fact>

The above data is associated with a date to put a time frame on the data. Further, because Bolivia has two capital cities, both attribute values are listed when the condition is “All.” Such structure can be easily expanded to include additional attributes and attribute values, and nesting of attributes and attribute values. For example:

<Fact>

<Date>1 04 2002</Date>
<Condition>All</Condition>
<Country>

<Name>Bolivia</Name>
<Capital City>La Paz

<Size>20 sq. km.</Size>
<Population>1.5 million</Population>

</Capital City>
<Capital City>Sucre

<Size>4 sq. km.</Size>
<Population>100,000</Population>

</Capital City>
<Size>1098581 sq. km.</Size>
<Population>7.4 million</Population>
<Neighboring Countries>Peru, Brazil, Paraguay, Argentina, Chile
</Neighboring Countries>
<Domestic Products>Coca, gas, tin, oil, cotton, soy, sugar
</Domestic Products>
<Currency>Boliviano</Currency>

</Country>

</Fact>

FIG. 3 is a flowchart of an embodiment of a data auto-correction process 40 according to the teachings of the present invention. Process 40 receives text from a source, such as a document from a word processing application, a user's key strokes and pointing device input, an email message from a email application, a web page from a browser, a data file from a directory, or another form of document, as shown in block 42. Process 40 then analyzes the data and tags the parts of speech to identify the grammatical role and parts of speech, such as noun, verb, adjective, adverb, etc., as shown in block 44. Most parts-of-speech tagging applications rely on the use of large corpuses of text and hidden Markov Models for identifying and determining the parts of the speech. Because most useful facts for correction are for proper nouns, this step may simply search for and identify the proper nouns. In addition, this step searches for and identifies factual data, such as nouns, cardinal numbers, directions, etc. In block 46, the proper nouns (elements and attributes) and the factual data (attribute values) are identified and properly associated with one another. A sophisticated way to accomplish this function is to perform a semantic analysis of the sentences and search for associations within the sentence and between sentences. For example, if a “Population” attribute is identified, the nearest identified “City” element and nearest “Number” attribute for the “Population” attribute are identified. It is apparent that as parts-of-speech tagging become increasingly more advanced, the error rate of incorrect attribute value to attribute would be reduced. Yet another way to improve the accuracy of this function is to check whether the fact provided is closer to which nearby pronoun. For example, if a number has been identified for a “population” attribute and has a value of 1 million, then an association may be made to the city of LaPaz, since the 1 million population is closer to the actual population of LaPaz and not Bolivia or Sucre.

Thereafter in block 48, the attribute values are compared with the data stored in the fact database for the same element and attribute. If the values are different, as determined in block 50, then a suggested change for the data may be made, as shown in block 52. For example, a pop-up window 60 may appear on the screen, such as the one shown in FIG. 4. Exemplary alert window 60 comprises a statement 62 that provides information on the element and attribute that have the erroneous attribute value, the erroneous value, and the correct value. Further, two clickable buttons 64 and 66 may be provided to allow the user to elect to make the substitution or ignore the suggestion, respectively. Such pop-up windows are likely best suited for word processing applications where the user is entering the data. Alternatively, the attribute value may be highlighted on the screen to allow the user to click on and obtain and replace it with the correct data. In certain other applications, the user may configure process 40 to automatically correct factual data in real-time as erroneous data are identified without alerting the user or otherwise requiring the user to take additional steps to correct the facts.

The automatic data checking and correction system and method solves the problem of having to separately and manually verify facts as one is preparing a document or reading a document. Professionals such as actuaries, accountants, managers, engineers, teachers, and others will benefit from having their databases tied to their document generation software. In this way, the data is at the user's fingertips and is automatically put into action to ensure documents contain the proper facts. Another benefit to the users is the ability to differentiate good data from bad data. This is especially important today where users are inundated with voluminous data from the World Wide Web, where the data may be wrong, mis-stated, mis-characterized, or outdated. Students having to do research for school projects will have special appreciation for such a tool to verify data obtained from various sources. It may be seen that the users benefit by increasing productivity and improving the accuracy of the work product.

The automatic data checking and correction system and method may be bundled with various software applications, such as word processing applications and web browsers. Furthermore, the automatic data checking and correction system and method is an automated data delivery system and service for data warehouses and databases. For example, an encyclopedia publisher may wish to put the encyclopedia data in a database to enable its subscribers to access and use the data using the system and method of the present invention. As the publisher updates the data in its database, its subscribers benefit by having access to the most recent data and using it in an automatic way to check the documents they prepare or read. Publishers of other documents and books, such as text books, the Christian Bible, news magazines and newspapers, and the like will also benefit from this service delivery methodology. Various facts, trivia, place names, people names, etc. may be automatically checked using this database. Not only its own employees may benefit from accessing such a database, but its paid subscribers will also benefit from having factual data so readily available at the desktop.

What is claimed is:

1. A method of automatic data checking and correction, comprising:
receiving a textual input having at least one attribute value;
associating the at least one attribute value with at least one respective element and attribute;
comparing the at least one attribute value from the textual input with attribute values stored in a database for the respective elements and attributes; and
replacing the at least one attribute value in the textual input with the stored attribute value in response to the at least one attribute value being different from the respective stored attribute value.

2. The method, as set forth in claim 1, further comprising identifying elements, attributes and attribute values in the textual input.

3. The method, as set forth in claim 2, wherein identifying elements, attributes and attribute values comprises identifying parts of speech in the textual input.

4. The method, as set forth in claim 2, wherein identifying elements, attributes and attribute values comprises identifying proper nouns and factual data in the textual input.

5. The method, as set forth in claim 1, wherein receiving a textual input is selected from the group consisting of reading a text document, reading a web page, and receiving a user's keyboard input.

6. The method, as set forth in claim 1, further comprising:
alerting a user that an erroneous fact is present in response to the identified attribute values being different from the respective stored attribute values; and
substituting the identified attribute values with the stored attribute values in the textual input at the user's request.

7. The method, as set forth in claim 1, further comprising:
receiving data;
identifying elements, attributes and attribute values in the received data;
associating the identified attribute values with respective elements and attributes; and
storing the identified elements, attributes and attribute values.

8. The method, as set forth in claim 1, further comprising:
receiving data having identified elements and attributes, and attribute values associated therewith; and
storing the identified elements, attributes and associated attribute values in a database.

9. The method, as set forth in claim 1, further comprising:
receiving data having at least one identified element and attribute, and at least one attribute value associated therewith;
storing the at least one identified element, attribute and associated attribute value in a database;
receiving at least one query regarding specific attribute value associated with specific element and attribute; and
retrieving the queried specific attribute value and delivering to a user initiating the at least one query.

10. The method, as set forth in claim 1, further comprising:
generating a query regarding a specific attribute value associated with specific element and attribute; and
sending the query to the database;
receiving the specific attribute value and delivering to a user initiating the query.

11. A method of automatic factual data delivery to the desktop, comprising:
receiving a textual input;
associating at least one attribute value with at least one respective element and attribute in the textual input;
querying a database regarding the at least one attribute value;
retrieving at least one stored attribute value from the database;
comparing the at least one attribute value from the textual input with the at least one stored attribute value retrieved from the database for the at least one respective element and attribute; and
replacing the at least one attribute value in the textual input with the at least one stored attribute value in response to the at least one attribute value being different from the at least one stored attribute value.

12. The method, as set forth in claim 11, further comprising identifying at least one element, attribute and attribute value in the textual input.

13. The method, as set forth in claim 12, wherein identifying at least one element, attribute and attribute value comprises identifying parts of speech in the textual input.

14. The method, as set forth in claim 12, wherein identifying at least one element, attribute and attribute value comprises identifying proper nouns and factual data in the textual input.

15. The method, as set forth in claim 12, wherein receiving a textual input is selected from the group consisting of inputting a text document, downloading a web page, and receiving a user's keyboard input.

16. The method, as set forth in claim 12, further comprising:
alerting a user that an erroneous fact is present in response to the at least one identified attribute value being different from the respective stored attribute value; and
substituting the at least one identified attribute value with the stored attribute value in the textual input at the user's request.

17. The method, as set forth in claim 12, further comprising:
receiving data;
identifying elements, attributes and attribute values in the received data;
associating the identified attribute values with respective elements and attributes; and
storing the identified elements, attributes and attribute values.

18. The method, as set forth in claim 12, further comprising:
receiving data having identified elements and attributes, and attribute values associated therewith; and
storing the identified elements, attributes and associated attribute values in a database.

19. A system of automatic data checking and correction, comprising:
a computer-readable medium having encoded thereon a process operable to:
receive an input having elements, attributes and attribute values;
associate the attribute values with respective elements and attributes;
compare the attribute values from the input with attribute values stored in a database for the respective elements and attributes; and
replace the attribute values with the stored attribute values in the input in response to the attribute values in the input being different from the respective stored attribute values.

20. The system, as set forth in claim 19, wherein the process is further operable to identify parts of speech in the input to identify the elements, attributes, and attribute values.

21. The system, as set forth in claim 19, wherein the process is further operable to receive a textual input selected from the group consisting of a text document, a web page, and a user's keyboard and pointing device input.

22. The system, as set forth in claim 19, wherein the process is further operable to:
alert a user that an erroneous fact is present in response to the attribute values in the input being different from the respective stored attribute values; and
substitute the attribute values in the input with the stored attribute values in response to a request from the user.

23. The system, as set forth in claim 19, wherein the process is further operable to:
receive data having identified elements, attributes and attribute values;
associate the identified attribute values with respective elements and attributes; and
store the identified elements, attributes and attribute values.

24. The system, as set forth in claim 23, wherein the process is further operable to:
receive queries regarding specific attribute values associated with specific elements and attributes; and
retrieve the queried specific attribute values and delivering to a user initiating the queries.
